(19) United States
(12) Patent Application Publication
(10) Pub. No.: US 2003/0183326 A1
(43) Pub. Date: Oct. 2, 2003

(54) Method for manufacturing pressure sensitive adhesive tear tapes

(76) Inventor: Lawrence O'Connor, Nokomis, FL (US)

Correspondence Address: ADE & COMPANY, 1700-360 MAIN STREET, WINNIPEG, MB, R3C3Z3, CA

(21) Appl. No.: 10/113,933

(22) Filed: Apr. 2, 2002

(51) Int. Cl. B32B 31/00

(52) U.S. Cl. 156/187; 156/259; 156/229

(57) ABSTRACT

A method for manufacturing pressure sensitive adhesive tear tape for use in tearing an overwrap material includes providing a web of a polymeric material which is biaxially-oriented, slitting the web into a plurality of side by side continuous tapes, drawing each continuous tape longitudinally to effect additional longitudinal orientation of the tape and winding each tape into a separate spool. In a second separate process, the tapes side by side are unwound and passed through a printing line where a coating of a pressure sensitive adhesive is applied to the first tape surface and a coating of a release agent is applied to the second tape surface to provide a release action relative to the adhesive. Each continuous tape with the adhesive coating thereon is wound into a respective cylindrical tape spools for supply to the packaging line.

This invention relates to a method for manufacturing pressure sensitive adhesive tear tapes.

### BACKGROUND OF THE INVENTION

Tear tapes for use in tearing an overwrap packaging material are used in many different packaged products. The tear tape is adhesively attached to the inside surface of the overwrap material between the overwrap material and the packaged product.

This system has been in effect for many years and for the majority of those years the tear tapes were formed of a simple mono-axially oriented plastics material supplied individually from supply spools. In some cases the plastics material carries a colorant so that the tape is of a different color from the overwrap material. On line with the overwrap material, an adhesive is applied to the tape after it is unwound from the supply spool and prior to its attachment to the overwrap material. Thus the spooled supply of the tear tape is free from adhesive and free from any release coats and is thus a simple product to manufacture formed solely by the base plastics material itself.

One technique for manufacturing a tear tape of this type involves extruding the plastics material, casting the extruded material in a wide sheet form onto a chilling surface so as to form a cast sheet, slitting the cast sheet into a plurality of individual tapes, longitudinally drawing the tapes so as to provide longitudinal or mono-axial orientation of the tapes and winding the tapes into a traverse or helically wound spool for supply to the packaging line.

As the formed tape in its wound condition comprises only the plastics material itself, it is possible to readily recycle trim waste formed during slitting of the tapes from an initial web and any waste generated during transfer of winding from one spool to the next. Such materials can simply be fed back to the extruder and re-extruded with the feed material.

Tapes of this type have been manufactured by a number of manufacturers for up to 40 years and are widely accepted.

In the late 1980's a new product was introduced in which the tape in its spooled form is supplied with a pressure sensitive adhesive already applied onto one surface of the tape. This product had the significant advantage that it was no longer necessary to apply adhesive on line with the packaging system thus avoiding the difficulty of feeding the adhesive onto the tape which may be stopping and starting with the packaging line.

The pressure sensitive adhesive tape became therefore adopted to some extent in the industry but still the majority of tear tapes are of the simple type where the adhesive is applied on line.

One disadvantage of the pressure sensitive tear tape which has reduced its acceptance is the significantly increased cost of the product. To some extent this increased cost arises due to the difficulty of manufacture.

Some tear tapes are manufactured by extruding a web of polypropylene, polyester or other suitable material, which is then drawn in machine direction to effect orientation of the extruded layer. The amount of draw possible is limited by the tendency of the material to fibrillate beyond a predetermined extension. After the longitudinal draw is effected, the web is drawn in the transverse direction by a tentering frame which increases the total orientation up to a level to give the required mechanical properties of strength and resistance to elongation. This material is known as biaxially oriented. This web is then slit into a plurality of longitudinally continuous side-by side tapes which can be coated with adhesive in a process subsequent to the slitting as in the O'Connor patent set out below or can be coated in web width with the adhesive prior to slitting as in the May patent above. However, the mechanical limitations of the orientation process limit the amount of orientation, which can be effected so that the resultant product is of reduced strength and increased thickness relative to the theoretical optimum.

When the pressure sensitive adhesive onto the sheet in web width, the sheet is slit in a preliminary slitting process into a plurality of primary webs, each of which is then wound into a fresh supply roll. The width of the individual primary rolls must be matched with the width of the intended tapes and the number of those tapes in order that the number of tapes slit from the web equal the limited number of spooling wind-up heads available. Each primary roll is then slit in a subsequent operation to form the requisite number of tapes, following which, the tapes are individually wound into separate traverse wound spools each on a respective one of the spooling wind-up heads. This process of slitting and rewinding into primary rolls does not add value to the product so that it is simply a wasted cost. In addition, the repeated unrolling and re-rolling of the material can degrade the adhesive by exposing the adhesive to the air and by the effect of repeated contact with the release coating. Yet further, each slitting action requires a further loss of trim waste from the edges of the primary rolls so that the trim waste can in total constitute a significant proportion of the original web width at a significant cost.

This process for manufacturing the tape has a number of significant disadvantages.

Firstly it is necessary to effect slitting of the film through the layer of adhesive which is applied thereto. Slitting through adhesive is well known to be problematic in that the adhesive attaches to the slitting knife and can form balls of adhesive which can break away and interfere with the travel and processing of the tapes.

Secondly the trim waste, which is necessary at each slitting process, causes high losses in the proportion of total waste relative to the quantity of finished material leading to significantly increased material cost. Where the trim waste carries adhesive material, it is impossible to carry out a recycling process.

Thirdly in order to complete a full spool of the tear tape, it is necessary to splice together end to end the primary rolls as they are unwound, since the length of the tear tape on the spool is considerably longer than the length of the sheet on the primary roll. In the finished spool, therefore the tear tape may have a series of splices through its length and these splices are difficult to carry out due to the presence of the release coat and are often functionally problematic in the packaging line on which the tear tape is to be used. This compares unfavorably with conventional non-adhesive tear tapes which are usually splice free.

The additional slitting of primary rolls described above and also the splicing necessary for the individual primary rolls provides a significant additional cost in the process both of labor and equipment thus dramatically increasing the cost of the product relative to the conventional non-adhesive tear tape.

Despite these difficulties, the above manufacturing process has been used widely by a number of manufacturers and continues to be the pre-eminent technique which is used for manufacturing of these tapes.

One example of a tape of this type manufactured by this technique is described in U.S. Pat. No. 5,203,935 of May et al assigned to Payne Packaging Ltd. who are a significant manufacturer of the product of this type.

In view of these difficulties in manufacture, attempts have been made over a period of at least ten years to find a technique which will improve the manufacturing process to allow manufacturing of PSA tear tapes at a reduced cost.

U.S. Pat. No. 4,887,714 of the present inventor O'Connor discloses a technique in which an oriented sheet of material is slit prior to the application of the adhesive so that the adhesive is applied to the individual tear tapes in a width less than the width of the tape, prior to winding of the tape into a supply spool for supply to the packaging machine. This technique has achieved some success and provides some advantages but has been unable to compete effectively with the conventional technique shown in the above patent of May or with the conventional non-adhesive tape.

U.S. Pat. No. 5,730,354 discloses a further improvement to the 714 patent in which the printing of indicia is applied onto the exposed surface of the adhesive. However the basic technique and manufacture of the tape is not changed.

Further attempts to improve the technique for manufacture were disclosed in U.S. Pat. No. 5,520,868 of the present inventor which discloses an arrangement in which individual tapes are separately extruded, the adhesive is applied immediately after extrusion, and the tape with the adhesive carried on the tape are then drawn longitudinally to provide the necessary orientation and to reduce the thickness of the adhesive layer. This technique has failed to achieve any commercial attention.

Tear tapes as defined herein generally have a low elongation to break which is generally of the order of 10 to 20% and certainly less than 40%. Although some specialized tear tapes are wider, the vast majority of tear tapes generally have a width less than ¼ inches and often down to 1/16 inch.

### SUMMARY OF THE INVENTION

It is one object of the present invention, therefore, to provide an improved method of manufacturing a pressure sensitive adhesive tear tapes which provides improved economics of manufacture and eliminates some technical problems.

According to a first aspect of the invention, therefore, there is provided a method for manufacturing pressure sensitive adhesive tapes comprising:

providing a web of a polymeric material which is biaxially-oriented;

continuously forwarding the web;

passing the web as it is forwarded through a slitting assembly arranged to slit the web at transversely spaced positions into a plurality of side by side continuous tapes, each having first and second tape surfaces and two tape edges;

after slitting, drawing each continuous tape longitudinally to effect additional longitudinal orientation of the tape;

after drawing, applying a coating of a pressure sensitive adhesive to the first tape surface;

after drawing, applying a coating of a release agent to the second tape surface to provide a release action relative to the adhesive;

and continuously and separately winding each continuous tape with the adhesive coating thereon into a series of cylindrical tape spools each containing a length of the tape.

Preferably the web is supplied in a roll which has been biaxially oriented in previous separate process, but in an alternative arrangement, the process can be run in line where the web is oriented, slit and the tapes longitudinally drawn on one processing line.

The tapes may be heat set during drawing but more preferably are heated during drawing to a temperature less than the heat set temperature.

Preferably the method includes after drawing and before applying the adhesive, applying printed indicia to the first tape surface.

Preferably each tape is drawn to a thickness less than 35 microns and preferably less than 20 microns.

Preferably the tapes have a width in the range 1.6 to 10 mm.

Preferably the tapes have an elongation to break less than 40%.

The adhesive layer may be applied in a width less than the width of the tape. Particularly where the tape is wider than the order of 6 mm, the adhesive may be applied in bands narrower than the width of the tape such that a bare space is provided between two bands which are applied at or adjacent the edges to ensure adhesion at the edges while minimising the amount of adhesive applied to minimize cost.

Preferably, prior to applying the adhesive to the second surface, the tape surfaces are treated by corona discharge

Preferably, during slitting, edge portions of the web are slit off and the portions returned for recycling.

Preferably the method includes adding security taggant material to the tape for use in subsequently verifying a manufacturer of the tape, the taggant material being added to the plastics material, the adhesive or the ink.

Preferably the tapes are continuously wound at the end of the process including the expensive coatings without loss of tape as the tape winding transfers from one spool to another.

Preferably the release coating is applied by kiss coating the tapes without an impression roller so as to apply the release coating also to the edges of the tapes.

Preferably in a first process the web is slit and the slit tapes each wound into a respective spool and wherein in a second process the spools are unwound, the tape coated with the adhesive and rewound into a supply spool. In this arrangement, the first process is run at a higher speed than the second process.

Preferably in the second process a plurality of the spools are simultaneously unwound to supply the tape therefrom to a coating line in which the release coating is applied to the second tape surface of each tape and the coating of the pressure sensitive adhesive is applied to the first tape surface of each tape and wherein each continuous tape with the release coating and the adhesive coating thereon is wound into a series of cylindrical tape spools each containing a length of the tape.

According to a second aspect of the invention, a method for wrapping an article with a tearable wrapping film comprises:

forming a tear tape by the method defined above;

supplying the wrapping film;

applying the tear tape to the wrapping film such that it is attached thereto by the adhesive;

wrapping the wrapping film around the article and heat shrinking the wrapping film to engage tightly around the article;

and selecting a draw ratio for the drawing of the tape such that the elongation of the tape so formed is matched to that of the wrapping film such that the heat shrinking is effected without puckering of the tear tape.

The tapes are traverse wound into spools either by continuous traverse movement or by intermittent traverse movement.

This method has the advantages that it

a) allows the recycling of uncoated material directly back to the extruder;

b) avoids slitting through adhesive;

c) provides a tear tape of increased strength to thickness so as to allow the manufacture of tear tapes of reduced thickness and thus reduced materials.

### BRIEF DESCRIPTION OF THE DRAWINGS

One embodiment of the invention will now be described in conjunction with the accompanying drawings in which:

FIG. 1 is a schematic illustration of a method for manufacturing a tear tape according to the present invention.

FIG. 2 is an isometric view of a package including an overwrap material and a tear tape attached thereto.

FIG. 3 is a cross sectional view of two overlapping portions of the overwrap material at a seam where the tear tape passes through the seam.

In the drawings like characters of reference indicate corresponding parts in the different figures.

### DETAILED DESCRIPTION

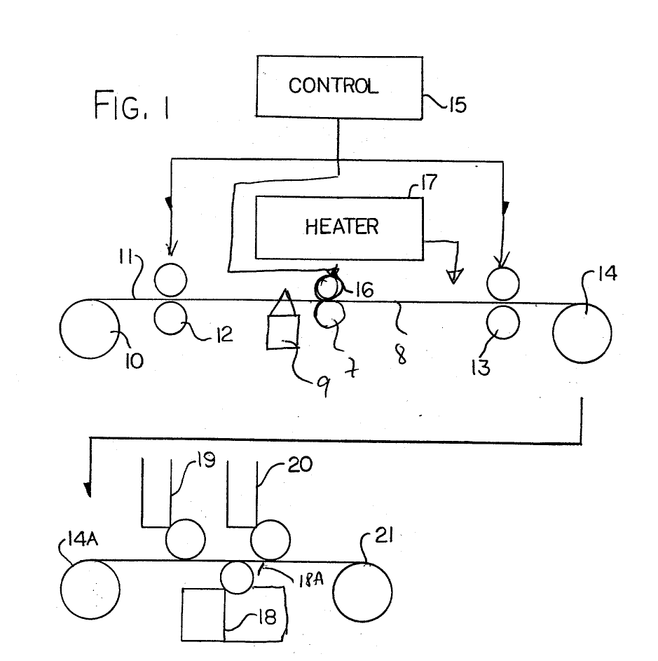

In FIG. 1 is shown a supply 10 of a web 11 of a bi-axially oriented film of a suitable polymer material. Preferably material is polyester but other materials such as polypropylene, polyethylene and nylon can also be used in some cases. The preferred material is polyester.

The film when supplied has a thickness in the range 0.00048″ to 0.0020″. The elongation of the film in the longitudinal direction will range from 80 to 120% and 60 to 90% in the transverse direction.

The film when supplied is biaxially oriented that is it has been initially oriented in a longitudinal direction and subsequently oriented in the transverse direction to provide orientation in both directions as opposed to the single longitudinal direction of monoaxially oriented materials. The tensile strength of the film in the longitudinal direction will range from 20,000 to 30,000 psi and 30,000 to 35,000 psi in the transverse direction.

Commercial material is available from a number of suppliers including for example DUPONT and Mitsubishi.

In the arrangement shown in FIG. 1, the film in its initial biaxially oriented state is passed through a feed roll system 12 for controlling a feed speed of the sheet. The sheet is then fed through a slitting section 9 including a series of transversely spaced slitting knives arranged to slit the sheet into a plurality of side by side tapes 8.

The slit tapes are then fed through a feed control system 7 which control the forward speed of the tapes to match the speed of the sheet from the feed control 12.

The tapes 8 then pass from the control 7 to a further speed control system 13 which is driven at increased speed relative to the control 7 so as to effect drawing of the tapes within a heated draw zone 6.

The tapes are then carried forwardly from the feed rollers to a wind up section 14 in which the individual drawn tapes are separately wound using conventional technology into individual spools of the tape.

The feed controls 7 and 13 are operated at predetermined speed ratio controlled by a drive control system 15 of a conventional nature. Thus a predetermined level of draw can be provided between the rollers 7 and 13 so as to increase the speed of the film as it is drawn away from the drawing section 6 between the two sets of rollers. In a heating section the sheet material can be heated by a heater 17 such that the material is heated to a temperature to allow drawing to be effected. While shown only schematically, the heating section generally will include pre-drawing rollers, drawing rollers and an annealing roller (not shown) which are heated to a temperature to allow drawing to be effected.

The sheet is maintained in web width by the rollers 12 and the individual tapes are maintained side by side as the tapes pass through the drawing section from the rollers 6 to the roller s 13 and into the winding section 14.

At the rollers 7 or at the rollers 13, the tapes can be separated into two or more paths (not shown) so that the spacing between the tapes is increased. This can be done simply by spreading the tapes by passing them over suitably spaced guides or can be carried out by providing a second path for the tapes or the alternate ones of the tapes are divided onto the second path leaving a space for alternate tapes and for the winding assembly associated therewith.

The winding process is preferably substantially continuous except that less expensive winding processes can be used since it is possible to discard portions of the tape generated as winding is transferred from a filled spool to a fresh core. The discarded portions of the tape are uncoated and thus formed solely from the polymer and thus can be returned to an extrusion process for recycling with the primary material. Transfer of winding can therefore be effected manually.

The preferred separation of the process into two separate steps require winding of the tape twice at the winding system 14 and again at the winding system 21 but this disadvantage is more than outweighed by the ability to more accurately control the separate processes and to run the separate processes at their maximum speeds where the speed of the first process may be significantly higher than can be accommodated by the printing line of the second part of the process.

The individual tape spools from the winding section 14 are passed to a feed supply 14A for feeding a second section of the process in which the drawn tapes are coated on their underside by a coating system 18 applying a release coat material of conventional nature. On the upper surface of the tapes is applied initially an optional printing step 19 which applies band of printed information or simple printed colored lines along the length of the sheet. Downstream, or in some cases upstream of the printing section is a coating section 20 which applies a conventional pressure sensitive adhesive material over the individual tapes. The adhesive is applied to the tapes in one or two narrow bands having a width less than that of the tape itself. Where one band is applied, this leaves side edges of the upper surface of the tapes which is bare of the adhesive. Where two bands are applied, these are generally applied at or adjacent the edges to ensure adhesion at the edges leaving a space along the center, thus reducing the amount of adhesive used to minimize cost.

The coating assembly 18 (shown only schematically) is preferably of the kiss coating type in that the tape passes across the surface of a roller in contact therewith over a shallow angle of the order of 20°. The roller runs in a bath of the liquid material to be applied to the tape and thus floods the bottom surface and the side edges of the tape so as to coat those surfaces and edges with the liquid material. Downstream of the kiss contact, the tape and/or the roller is stripped by a doctor blade 18A so as to remove excess coating material.

The materials are dried and set so that the tapes carrying the applied materials are wound into a section 21 to form further supply spools 21A.

Tape winders of a type suitable for the above method are commercially available from Kampf in Germany and provide a turret arrangement by which each cylindrical spool is moved away from the winding location after that spool is completed so as to commence winding on a new fresh core. The transfer takes place without generating a discarded length of tape so that no tape is wasted.

Thus when formed each tape is defined by a base film material 30 and a covering adhesive layer 31 which extends to an edge 31A of the adhesive spaced from the edges of the tape as indicated in FIG. 3. An optional printing layer 32 is applied on the upper surface of the tape with the adhesive layer 31. An opposite release coating 33 is carried on the tape to prevent bonding of the reverse side of the tape to the adhesive layer during the packaging process.

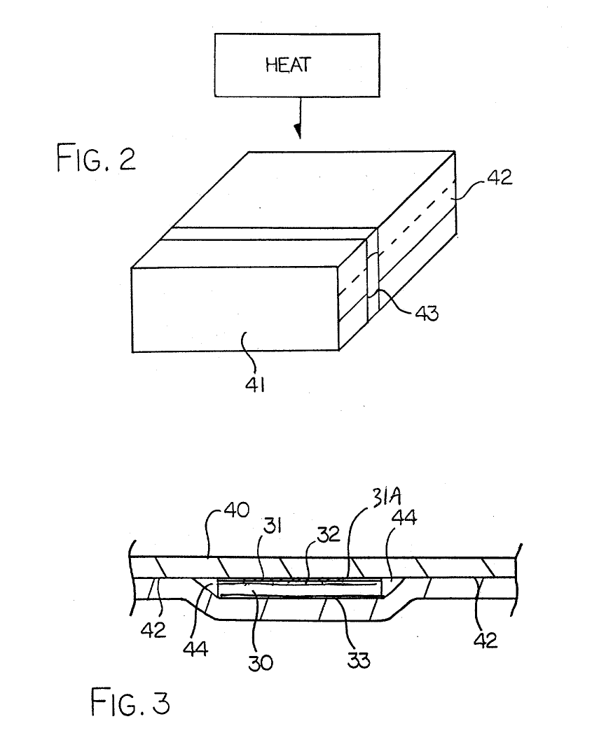

As shown in FIGS. 2 and 3 the tear tape defined by the base film 30 and the adhesive layer 31 is attached to an overwrap material 40 so that it is carried thereby. The overwrap material is wrapped around a packaged article 41 such as a pack of cigarettes or the like. The overwrap material is overlapped at a seam 42 and the tear tape passes through the seam from underneath the overwrap material so that a tab 43 of the tear tape is exposed at the seam for pulling of the tear tape to effect tearing of the overwrap material 40.

As shown in FIG. 3, at the seam 42 on either side of the tear tape there is a narrow area 44 defined by the finite thickness of the tear tape which can allow penetration of air and escape of moisture thus allowing the contents to be increased or decreased in moisture content with the possibility of spoilage of the contents after a period of storage.

According to the present invention, the additional drawing step of the biaxially oriented tape material allows the tape to be reduced in thickness from a conventional thickness of the order of 45 microns down to a thickness which is less than 35 microns and more preferably less than 20 microns. It is the intention to minimize the thickness of the finished tape while providing sufficient longitudinal strength. This allowable thickness reduction in the finished tape is obtained due to the fact that the longitudinal strength is relatively significantly increased by the additional drawing of the film. As the tapes are drawn, the width is also slightly decreased so that the slit width must be selected relative to the draw ratio and the thickness so that the final width is equal to the required width.

Of course, in order to provide a predetermined strength which is necessary for the tearing action, a predetermined longitudinal strength is required which is of the order of 40,000 lbs per square inch (which equates to an absolute value of 1.5 lb. for a tape of the order of 0.0787 inches in width and 0.00048 inches in thickness). Thus the strength of the tape should be greater than 1.5 lbs.

In order to achieve this in conventional tear tapes, a thickness greater than 35 microns is normally required since thinner material does not have the sufficient strength characteristics. However the increase in strength provided by the present invention allows a significant reduction of the thickness of the material and thus significantly reduces the dimensions of the air penetration zones 44.

Yet further, significant reduction in the thickness of the tape acts to allow formation of a package of significantly increased length of material since the package can only be formed up to a predetermined diameter and therefore a reduction in thickness generates an increase in length within the predetermined volume of the finished package. This increase in length on a supply package has significant ergonomic improvements allowing reduced operator down time.

Yet further it has been found that the slit edges of a tape formed in this manner are improved relative to those generated from mono axial oriented materials since the transverse orientation allows an enhanced slitting action thus avoiding the generation of slitting problems and the generation of stray fibers or fibrillation at the slit edges.

In a particularly preferred process, the overwrap material when applied to the package 41 is of a character which allows a heat shrink action to occur so that the overlap material is pulled down tight onto the outside surface of the package thus avoiding bubbles and wrinkles which detract from the appearance of a the graphics on the printed outside surface of the package itself. Yet further, the longitudinal extension of the tear tape can be controlled by modifying the draw ratio controlled by the drive system 15 and the draw temperature so that the elongation is tailored to the particular heat shrink characteristics of the overwrap material. In this way puckering of the tear tape during the heat shrink process is avoided since the characteristics of the tear tape are directly tailored to the characteristics of the overwrap material.

It has been determined that the amount of elongation or extension in the tear tape can effect the puckering of the overwrap film when the tear tape is applied. If the tear tape has a low elongation in the range of 15 to 30% the puckering of the tear tape is noticeable. If the tear tape has an elongation in the range of 30 to 60% the puckering appears to be more controlled when the tear tape is applied to the overwrap film. The heat that is applied to the overwrap film causes the film to shrink or lose elongation in the longitudinal and transverse directions. The tear tape, because of the bi-axial orientation and heat set properties, will remain more stable with less puckering to the overwrap film when applied compared to a monoaxially oriented tape. The draw ratios to the tape that imparts elongation characteristics from a range of 15 to 60% are from a range of 1.3/1.0 to 1.8/1.0.

In order to provide an enhanced tear tape for security purposes, a security taggant material can be added to the tape. Such materials are readily available from Secure Products L.P. of Summit, N.J. and are of a nature which fluoresce at a predetermined frequency when excited by a light source. Such taggant materials can be selected by a particular manufacturer to identify the manufacturer or a particular batch of tape so that the finished products can be analyzed by assessment of the tear tape to determine the origin of the products and any particular characteristics concerning those products.

The taggant material and can be applied into the original polymer for extrusion with the basic film or can be applied to the adhesive or the ink as a coating on the film.

Since various modifications can be made in my invention as herein above described, and many apparently widely different embodiments of same made within the spirit and scope of the claims without departing from such spirit and scope, it is intended that all matter contained in the accompanying specification shall be interpreted as illustrative only and not in a limiting sense.

I claim:

1. A method for manufacturing pressure sensitive adhesive tapes comprising:
providing a web of a polymeric material which is biaxially-oriented;
continuously forwarding the web;
passing the web as it is forwarded through a slitting assembly arranged to slit the web at transversely spaced positions into a plurality of side by side continuous tapes, each having first and second tape surfaces and two tape edges;
after slitting, drawing each continuous tape longitudinally to effect additional longitudinal orientation of the tape;
after drawing, applying a coating of a pressure sensitive adhesive to the first tape surface;
after drawing, applying a coating of a release agent to the second tape surface to provide a release action relative to the adhesive;
and continuously and separately winding each continuous tape with the adhesive coating thereon into a series of cylindrical tape spools each containing a length of the tape.

2. The method according to claim 1 wherein each tape is heat set at the drawing step.

3. The method according to claim 1 wherein the web or polymeric material is supplied in a roll which has been biaxially oriented in a previous separate process.

4. The method according to claim 1 including, after drawing and before applying the adhesive, applying printed indicia to the first tape surface.

5. The method according to claim 1 wherein each tape is drawn to a thickness less than 35 microns.

6. The method according to claim 1 wherein each tape is drawn to a thickness less than 20 microns.

7. The method according to claim 1 wherein the tapes have a width between 1.6 mm and 10 mm.

8. The method according to claim 1 wherein the tapes have an elongation to break less than 40%.

9. The method according to claim 1 wherein the adhesive layer is applied in a width less than the width of the tape.

10. The method according to claim 1 wherein the adhesive layer is applied in two bands each having a width less than the width of the tape and each arranged at or adjacent a side edge of the tape so as to leave a bare space between the bands.

11. The method according to claim 1 wherein, prior to applying the adhesive to the second surface, the tape surfaces are treated by corona discharge

12. The method according to claim 1 wherein, during slitting, edge portions of the web are slit off and the portions returned for recycling.

13. The method according to claim 1 including adding security taggant material to the tape for use in subsequently verifying a manufacturer of the tape, the taggant material being added to the plastics material, the adhesive or the ink.

14. The method according to claim 1 wherein the tapes with the adhesive coating thereon are continuously wound on a turret winder without loss of tape as the tape winding transfers from one spool to another.

15. The method according to claim 1 wherein the release coating is applied by kiss coating the tapes without an impression roller so as to apply the release coating also to the edges of the tapes.

16. The method according to claim 1 wherein in a first process the web is slit and the slit tapes each wound into a respective spool and wherein in a second process the spools are unwound, the tape coated with the adhesive and release coating and rewound into a supply spool.

17. The method according to claim 16 wherein the first process is run at a higher speed than the second process.

18. The method according to claim 16 wherein in the second process a plurality of the spools are simultaneously unwound to supply the tape therefrom to a coating line in which the release coating is applied to the second tape surface of each tape and the coating of a pressure sensitive adhesive is applied to the first tape surface of each tape and wherein each continuous tape with the release coating and the adhesive coating thereon is wound into a series of cylindrical tape spools each containing a length of the tape.

19. The method according to claim 16 wherein in the second process layer of printing is applied to the tape.

20. A method for wrapping an article with a tearable wrapping film comprising:
forming a tear tape by the method according to claim 1;
supplying the wrapping film;
applying the tear tape to the wrapping film such that it is attached thereto by the adhesive;
wrapping the wrapping film around the article and heat shrinking the wrapping film to engage tightly around the article;
and selecting a draw ratio for the drawing of the tape such that the elongation of the tape so formed is matched to that of the wrapping film such that the heat shrinking is effected without puckering of the tear tape.
